(19) United States
(12) Patent Application Publication
(10) Pub. No.: US 2005/0157495 A1
(43) Pub. Date: Jul. 21, 2005

(54) Conductor rail system for low-voltage luminairies and light-emitting diodes

(76) Inventor: Jochen Bruck, Freiburg (DE)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/948,616

(22) Filed: Sep. 22, 2004

(30) Foreign Application Priority Data
Sep. 23, 2003 (DE) 203 14 831.2

(51) Int. Cl. F21V 1/00

(52) U.S. Cl. 362/240; 362/800; 362/219; 362/225

(57) ABSTRACT

Conductor rails arrangement for low-voltage lamps comprising electrical conductors (11, 11′) serving as current phases with said conductors being separated by means of an insulator (12), wherein the electrical conductors (11, 11′) are designed as conductor rails with at least one of said rails serving as carrying structure (11′) and wherein the arrangement (1) comprises several light-emitting diodes (14).

The invention relates to a conductor rail system for low-voltage lamps comprising electrical conductors serving as current phases with said conductors being separated by means of an insulator.

Low-voltage power lines constitute the current-carrying elements of a system that depending on the number and type of its accessories consists of several power consumers and, if necessary, a transformer required to adjust the mains voltage to low-voltage requirements. The operation of such systems as a rule involves the use of low-voltage halogen luminaires or light emitters. They are arranged so as to cover large areas, for example entire rooms, to illuminate the room itself or certain objects located in the room.

The conductors constituting the current phases of such a system are separated electrically by means of an insulator but in most cases they form a composite material structure as they are usually mounted on the insulator. Normally, this composite material structure also has load-carrying functions.

Halogen spotlights are excellently suited for the localized illumination of objects, for example in business rooms or exhibitions. On the other hand, halogen lamps are less efficiently used for the illumination of entire rooms since their luminous field is significantly limited and, moreover, their luminous efficacy is poor in comparison to other light sources.

Light-emitting diodes (LEDs) consist of several layers of semiconductive material that converts electrical current directly into light according to the principle of a reversed solar cell. In the event of a current or power flow light is generated in one of the layers (the so-called active layer). The color of the light depends on the material that is used. Unlike incandescent lamps LEDs do not transmit the entire spectrum of different wavelengths but emit light of a certain color only. Nevertheless, with the help of luminescence converters white light can also be generated by means of light-emitting diodes.

Due to the fact that light-emitting diodes have a high efficiency and at the same time moderate directionality only, they are perfectly suited for the illumination of areas and rooms.

Customary conductor rail systems are usually of filigree design because, inter alia, they have to be adapted to the layout and ambiance of the rooms where they are arranged in. In these systems, to attain increased flexibility sacrifices are often made with respect to their load-carrying ability. On the other hand, it is desirable to provide systems having improved carrying capacity and, in particular, being able to accommodate and supply a variety of consumers.

It is, therefore, the objective of the invention to provide a conductor rail arrangement for low-voltage lamps and luminaires having a high carrying capacity, with said arrangement being able to accommodate without difficulty additional light-emitting diodes and, for that reason, being suited to illuminate not only entire rooms but at the same time satisfy localized lighting needs.

To achieve this objective and based on the conductor rail arrangement described hereinbefore the invention proposes that the electrical conductors are preferably designed as conductor rails arranged one upon the other, with one of said rails serving as carrying structure, and that the arrangement is fitted with several light-emitting diodes.

The conductor rail arrangement according to the invention offers benefits in that it may accommodate and energize both halogen spotlights and light-emitting diodes. Both lighting systems operate according to the low-voltage principle. For this reason, a common transformer can be employed. Since halogen spotlights may operate on both alternating current and direct current but LEDs on direct current only, it is necessary—at least to energize the LEDs—to make use of a rectifier. Expediently, however, the entire conductor rail system according to the invention is operated by means of direct current.

The halogen spotlights are connected to the electrical conductor rails in a traditional manner. They may be mounted either permanently fixed or hooked up so as to be movable in places where localized illumination is required. The LEDs mounted in the conductor rail arrangement according to the invention are permanently fixed in position, for which purpose they are expediently provided with their own power supply source. This offers the advantage that a circuit can be provided separate from the one serving the halogen spotlight. As an alternative, however, one of the two conductor rails may be integrated into the power supply of the LEDs; the other phase is arranged separately. In this case as well an independent circuit arrangement is possible.

Preferably, the conductor rail arrangement according to the invention is to operate on an AC voltage of 12 V as this is customary for illumination systems working according to the low-voltage principle. Since low-voltage lamps usually operate on alternating voltage while light-emitting diodes use direct voltage the system has to be provided with a rectifier. The transformer is advantageously arranged in the vicinity of the power source but may also be integrated into the conductor rail arrangement according to the invention. It is practical and beneficial to integrate the rectifier into the conductor rail arrangement, for example above one conductor rail or a carrier bar for tight-emitting diodes, but it is preferably integrated in a connector element provided for the purpose of connecting several conductor rails.

Preferably, the power conductors are made of aluminum. Other conductive materials may be employed optionally.

As insulating material especially plastic compounds are used, preferably thermoplastic plastic compounds. Especially silicone has proven its worth for the application.

The configuration and design of at least one of the two electric conductor rails as a carrier section, in case of rails mounted one upon the other preferably the lower one facing the room, lends excellent stability to the conductor rail arrangement according to the invention. Such a carrier section is doubtlessly capable of accommodating aside from a number of halogen spotlights in addition a plurality of light-emitting diodes including holders/mounting boards as well as their power supply system.

By carrier section any design of a conductor rail is understood that is capable of absorbing the loads exerted on it. This may be a simple box section, a plate-like, rather elongated rectangular section, a hollow section having hollow spaces that may serve to simultaneously accommodate plug connectors joining several rail segments, or a box-like section having legs standing out laterally. Said section conducts one of the two current phases and is suited to accommodate the arrangement of light-emitting diodes. Curved or arched conductor rails may also be employed.

The conductor rails may also be arranged in parallel side by side and both have carrying functions. In this case the light-emitting diodes are preferably arranged between the conductor rails on the underside (the one facing the room).

The light-emitting diodes themselves are mounted on a carrier rail or mounting boards and distributed preferably linearly over the length of the arrangement, in particular in the form of a row of LEDs located in the center of each rail. In this case they may be individually arranged in recesses located in the carrier section or on a carrier rail arranged on the underside (facing the room) of the carrier section and being secured, particularly, in a recess provided in longitudinal direction. Provided the carrier section is a box-shaped section open at the bottom with legs protruding laterally the rail carrying the LEDs is located in this box open at the bottom. The electrical means necessary to energize the LEDs are in this case invisibly located in the hollow space provided above the rail; only the diodes project through the rail.

In the region of the light-emitting diodes the conductor rail arrangement according to the invention may have a transparent cover, for example of glass or acrylic glass, said cover may also be of opaque design to produce a uniform light. Such a cover is expediently arched or dome-shaped in such a manner that it extends over the entire length of the arrangement.

As per a preferred embodiment the conductor rail arrangement according to the invention is of symmetrical appearance relative to a mirror plane of symmetry extending through its main axis.

The conductor rail arrangement according to the invention is designed as a pluggably connected system which means the individual conductor rails of defined length can be plugged together via a connector system so as to be electrically conductive; the individual segments may be of straight configuration or curved at various curvature radii. Connectors of this type are known to the skilled person from other conductor rail arrangements and may be modified without greater effort to form conductor rail arrangements according to the invention. The connectors may also be combined with holding elements by means of which the arrangement can be attached to room ceilings or walls. The recesses for the plug connectors are located on the front ends of the individual rail, and in this context profilings of the rails which at the same time serve for stabilization and carrying capacity improvement may expediently be used for this purpose. Such connectors make up the electrically conductive connections between the conductor rails and the mounting boards/carriers of the light-emitting diodes and can also accommodate the rectifiers and/or electrical feed lines.

Finally, the invention also relates to a combination comprising conductor rail arrangement and retaining elements for attachment to a surface and/or a rectifier and/or a transformer.

By way of the enclosed drawings the invention is explained below. The figures show:

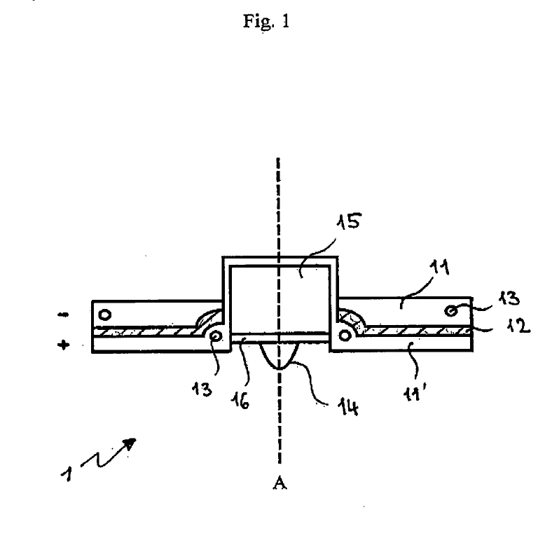

FIG. 1 a conductor rail arrangement according to the invention viewed from the front end;

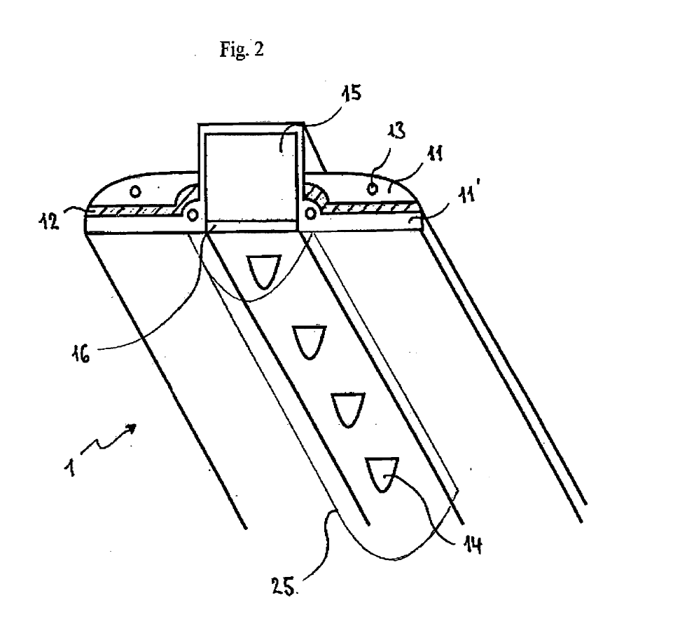

FIG. 2 another embodiment of the conductor rail arrangement according to the invention,

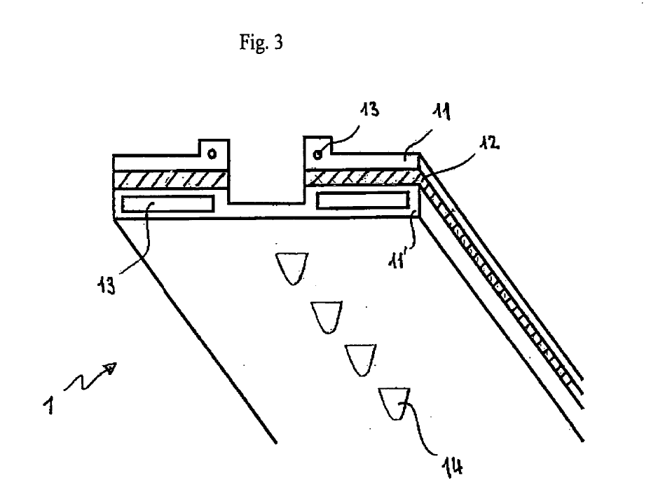

FIG. 3 another variant of the conductor rail arrangement according to the invention,

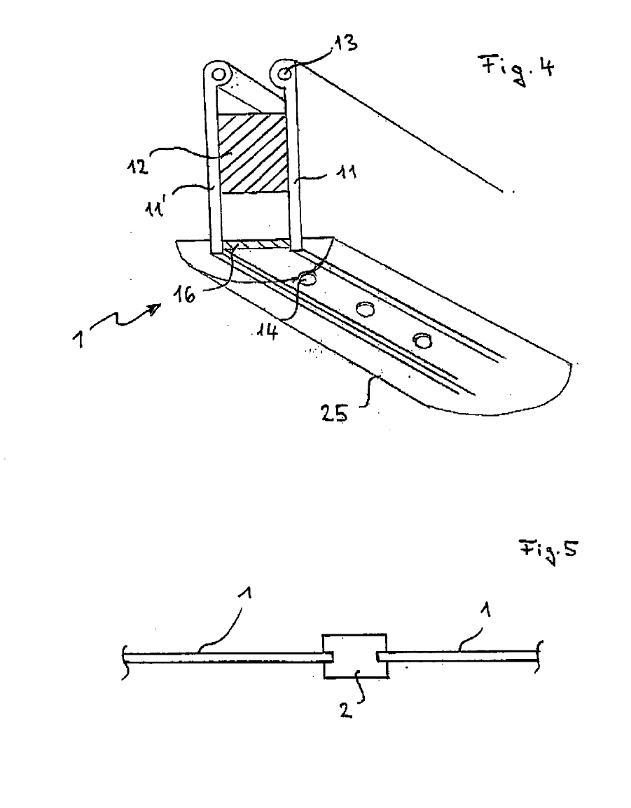

FIG. 4 a variant provided with conductor rails arranged side by side in parallel; and

FIG. 5 conductor rails joined by means of a connecting element.

FIG. 1 shows a conductor rail arrangement 1 with electric conductors 11, 11′ and insulator 12 located between the two electric conductors seen from the front end. The electric conductor 11′ is of box-shaped design with legs protruding at right angles. The recesses 13 accommodating the plug-type connectors are arranged in electric conductors 11, 11′ so that two rails of this type can be joined via said connectors. The electric conductor 11, for example, is the negative conductor, electric conductor 1l′ the positive one.

In the area of the box 15 a rail or carrier strip 16 with light-emitting diodes 14 is arranged. The power supply to the light-emitting diodes 14 is preferably arranged invisibly within the hollow space 15; said supply may be effected directly via a transformer and rectifier or indirectly via the conductor rails 11 and 11′ and an interposed rectifier in the event alternating current is supplied to the low-voltage rails. The relevant electrical connections have not been shown.

The conductor rail arrangement in accordance with FIG. 1 is of symmetrical design and is symmetrically divided through axis A which in fact is a vertically arranged mirror plane of symmetry.

For the operation of halogen spotlights said lamps are connected with the help of a conventional terminal system at the respective sides (right or left side of the mirror plane of symmetry A) to the electric conductors 11 and 11′.

FIG. 2 illustrates a variant of the conductor rail arrangement according to the invention comprising the two electric conductors 11 and 11′, the insulator rails 12, the recesses for the plug-type connectors 13 and a mounting board 16 with light-emitting diode units 14. To achieve a defined light distribution an opaque arched plastic covering 25 is arranged over the light-emitting diodes 14.

FIG. 3 shows another variant of a conductor rail arrangement 1 according to the invention comprising the electric conductors 11 and 11′, the insulating layer 12, recesses for plug-type connectors 13 as well as light-emitting diodes 14 mounted individually in recesses provided in the conductor rail 11′.

The conductor rail designed as carrier section may of course be arranged at the bottom or at the top (facing the room or the ceiling). In the latter case a bond between the electric conductors and the insulator is required that is capable of sustaining loads. The fastening elements to be used to secure the conductor rail arrangement according to the invention to a surface may be arranged both in the area of the rails and in the area of the plug-type connectors used to join the individual conductor rails of a system.

Following this, a variant with conductor rails arranged side by side is shown with both rails having carrying functions.

In FIG. 4 a variant of a conductor rail arrangement according to the invention is illustrated that has conductor rails 11 and 11′ arranged side by side in parallel and primarily vertically with said rails being insulated from each other by a continuous insulating block 12. The conductor rails have recesses 13 in their upper area to accommodate plug-type connectors by means of which several conductor rails can be joined with the aid of connecting elements. The insulating rail 12 consists of customary plastic material which may, for example, be stuck onto the conductor rails 11, 11′ made of aluminum. Alternatively or supplementary to the conductor rails the insulating rail 12 in this case may also have a carrying function.

In its lower area the conductor rail arrangement 1 is provided with a retaining rail 16 into which light-emitting diodes 14 are fitted. The retaining rail also accommodates the electrical connections and elements (not shown in the figure) needed to supply power to the light-emitting diodes.

For the operation of conventional low-voltage lamps these may be connected at the top side of the conductor rail arrangement in a customary manner.

To achieve a uniform and defined distribution of the light discharged by the light-emitting diodes 14 the conductor rail arrangement 1 is provided at its bottom side with a pushed-on opaque plastic covering 25.

FIG. 5 is a schematic representation of a conductor rail arrangement in which two conductor rails 1 are joined via their conductor rails 11 and 11′ making use of a connecting element 2. Said connecting element 2 is provided with the pins/contacts needed to establish the connection via recesses 13 and at the same time brings about the electrical connection between the adjacent conductor rails both for the low-voltage lamp portion and for the light-emitting diodes portion and, moreover, contains the rectifier for the operation of the light-emitting diodes portion. The transformer adapting the mains voltage to the needs of the system is preferably arranged in the area where the conductor rail arrangement is connected with the mains; the transformed power, however, may be advantageously fed to the conductor rail arrangement according to the invention via a connecting piece.

1. Conductor rail arrangement for low-voltage lamps comprising electrical conductors (11, 11′) serving as current phases with said conductors being separated by means of an insulator (12), characterized in that the electrical conductors (11, 11 ′) are designed as conductor rails, with at least one of said rails serving as carrying structure (11′), and that the arrangement (1) is fitted with several light-emitting diodes (14).

2. The arrangement according to claim 1, characterized in that the light-emitting diodes (14) are distributed linearly over the length of the arrangement.

3. The arrangement according to claim 1 characterized in that the light-emitting diodes (14) are arranged on a carrier rail (16) between the conductor rails (11, 11′).

4. The arrangement according to claim 1 characterized in that the electrical conductors (11, 11 ′) are designed as conductor rails arranged one upon the other, with one of said rails serving as carrying structure (11′).

5. The conductor rail arrangement according to claim 4, characterized in that the light-emitting diodes (14) are arranged in recesses (15) provided in the carrying structure (11′).

6. The arrangement according to claim 5, characterized in that the carrying structure (11′) is provided with a box-shaped recess (15) running in longitudinal direction, with the light-emitting diodes (14) being secured in said recess by means of a holding element (16).

7. Arrangement according to claim 1, characterized in that the carrying structure (11′) is provided with a transparent covering (25) in the area of the light-emitting diodes (14).

8. The arrangement according to claim 7, characterized in that the covering (25) is designed as a dome extending in longitudinal direction.

9. The arrangement according to claim 7, characterized in that the covering (25) is opaque.

10. Arrangement according to claim 1, characterized in that the conductor rails (11, 11′) are arranged primarily as a mirror reflection relative to a mirror plane of symmetry (A) extending in longitudinal and vertical direction.

11. Arrangement according to claim 1, characterized by recesses (13) for plug-type connectors, said recesses being situated at the front ends.

12. The arrangement according to claim 11, characterized by a connecting piece which via the plug-type connectors is joined with two or more elements of the conductor rail arrangement and is provided with a rectifier for power supply purposes.

13. Arrangement according to claim 1, characterized in that it comprises a transformer.

14. Arrangement according to claim 1, characterized in that it comprises plug-type connectors and retaining elements for attachment to a surface.
